(19) United States
(12) Patent Application Publication
(10) Pub. No.: US 2008/0183764 A1
(43) Pub. Date: Jul. 31, 2008

(54) CONTINUOUS PHYSICAL DESIGN TUNING

(75) Inventors: Nicolas Bruno, Redmond, WA (US); Surajit Chaudhuri, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/669,807

(22) Filed: Jan. 31, 2007

(51) Int. Cl. G06F 17/30

(52) U.S. Cl. 707/200; 707/E17.001

(57) ABSTRACT

Online physical design tuning is constantly monitoring database indexes and can effectively react to changes in a workload by modifying the physical design as needed. Algorithms can be utilized that take into account various criteria including storage constraints, update statements, and the cost of temporarily creating physical structures.

### CROSS-REFERENCE TO RELATED APPLICATIONS

This application is related to U.S. application Ser. No. ______, (Atty. Docket. No. MS318486.01/MSFTP1546US) filed ______, entitled “A LIGHTWEIGHT PHYSICAL DESIGN ALERTER,” the entirety of which is incorporated herein by reference.

### BACKGROUND

Electronic storage mechanisms have enabled accumulation of massive amounts of data. For instance, data that previously required volumes of books for recordation can now be stored electronically without expense of printing paper and with a fraction of physical space needed for storage of paper. Many users employ database systems for storage and organization of data and query such databases to retrieve desirable data. Database systems have been widely deployed and applications associated therewith have become increasingly complex and varied.

Complex queries are common in decision support and reporting scenarios. Query optimization tends to be expensive for such complex queries despite development of techniques to cope with such queries. In addition, physical design tuning of databases has become more relevant. Thus, database administrators spend a considerable time either tuning a less than optimal installation for performance or maintaining a well-tuned installation over time.

Automated tools take an offline approach and leave several decisions to database administrators or others. Such decisions include guessing when a tuning session is needed and to explicitly gather representative workloads and feed such workloads to a tuning tool.

### SUMMARY

The following presents a simplified summary in order to provide a basic understanding of some aspects of the disclosed embodiments. This summary is not an extensive overview and is intended to neither identify key or critical elements nor delineate the scope of such embodiments. Its purpose is to present some concepts of the described embodiments in a simplified form as a prelude to the more detailed description that is presented later.

In accordance with one or more embodiments and corresponding disclosure thereof, various aspects are described in connection with online physical design tuning for database systems. Algorithms can be employed that are continuously monitoring and, if needed, modifying the current database physical design. The various embodiments have low overhead (e.g., lightweight) and while modifying the physical design can take into account storage constraints, update statements, and the cost to create temporary physical structures.

To the accomplishment of the foregoing and related ends, one or more embodiments comprise the features hereinafter fully described and particularly pointed out in the claims. The following description and the annexed drawings set forth in detail certain illustrative aspects and are indicative of but a few of the various ways in which the principles of the embodiments may be employed. Other advantages and novel features will become apparent from the following detailed description when considered in conjunction with the drawings and the disclosed embodiments are intended to include all such aspects and their equivalents.

### BRIEF DESCRIPTION OF THE DRAWINGS

FIG. 1 illustrates a high-level block diagram of a system for online physical design tuning of databases.

FIG. 2 illustrates an execution plan that can be utilized with the disclosed embodiments.

FIG. 3 illustrates an AND/OR request tree in accordance with the disclosed embodiments.

FIG. 4 illustrates a block-diagram of a system that facilitates online physical tuning.

FIG. 5 illustrates an exemplary algorithm for a single-index case.

FIG. 6 illustrates a possible behavior for the single index case.

FIG. 7 illustrates differences in cost between sub-schedules.

FIG. 8 illustrates an online algorithm for the single index case.

FIG. 9 illustrates a block diagram of a system for online physical design tuning in accordance with the disclosed embodiments.

FIG. 10 illustrates a residual cost of an index and a benefit of an index.

FIG. 11 illustrates an exemplary pseudo-code for an online algorithm for physical design tuning.

FIG. 12 illustrates a block-diagram of a system that facilitates continuous online physical tuning.

FIG. 13 illustrates a method for continuous online tuning of databases.

FIG. 14 illustrates a block diagram of a computer operable to execute the disclosed embodiments.

FIG. 15 illustrates a schematic block diagram of an exemplary computing environment operable to execute the disclosed embodiments.

### DETAILED DESCRIPTION

Various embodiments are now described with reference to the drawings. In the following description, for purposes of explanation, numerous specific details are set forth in order to provide a thorough understanding of one or more aspects. It may be evident, however, that the various embodiments may be practiced without these specific details. In other instances, well-known structures and devices are shown in block diagram form in order to facilitate describing these embodiments.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Furthermore, the one or more embodiments may be implemented as a method, apparatus, or article of manufacture using standard programming and/or engineering techniques to produce software, firmware, hardware, or any combination thereof to control a computer to implement the disclosed embodiments. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed embodiments.

Various embodiments will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various embodiments disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

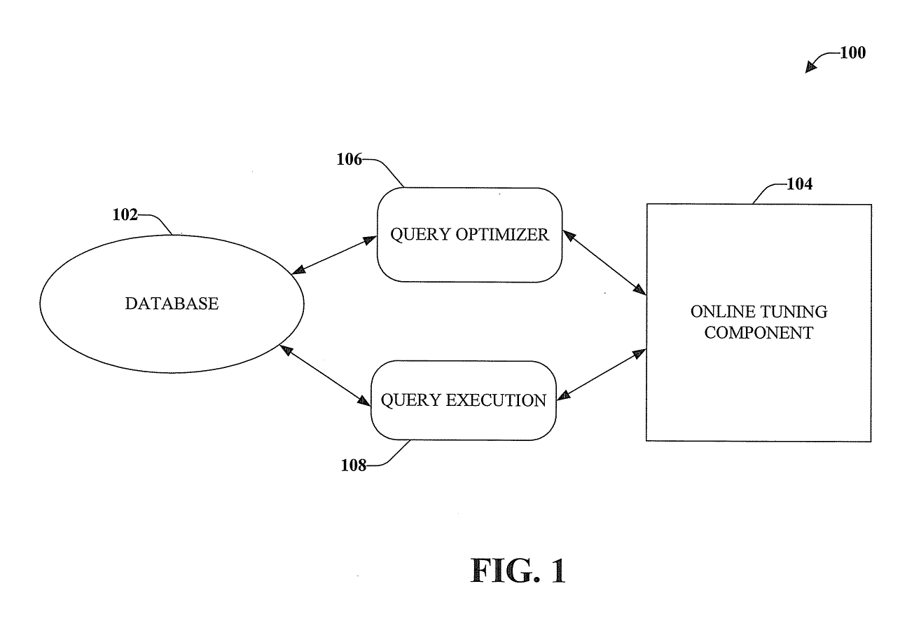

Referring initially to FIG. 1, illustrated is a high-level block diagram of a system 100 for online physical design tuning of databases. System 100 can be configured to automate physical design tuning for database systems. System 100 can employ algorithms that are always on and can continuously modify a current physical design and can react to changes in a query workload. Such a system 100 can have low overhead while taking into account storage constraints, update statements, and the cost of creating temporary physical structures.

Included in system 100 is a database 102 that can include one or more queries that include one or more columns that can be employed to index content of the database. For example, the database can include information relating to students in a college, and columns therein can include student names, expected graduation date, amount of tuition, credits taken per semester, major, and so forth. A tuition assistance department might be interested in compiling information relating to the students that are receiving tuition assistance while a marketing department might be interested in compiling information relating to work history after college, and so forth. Therefore, each department might compile a query and save such query, which can be utilized each time the information is desired, without requiring recompilation of the query.

Included in system 100 is an online tuning component 104 that can be configured to tune indexes in the database 102. For example, as queries are optimized, such as with a query optimizer 106, online tuning component 104 can obtain or determine which is the best available index to implement for each result. The query can be input by a user, automatically generated by a device employing the system, or generated in other manners. When a query is executed 108, such as when a user and/or entity (e.g., the Internet, another system, a computer, . . . ), hereinafter referred to as user, requests a query, the online tuning component 104 can identify a relevant set of candidate indexes that could improve performance. Thus, online tuning component 104 can continuously monitor the optimized or executed query and determine an index to keep and/or an index to drop by utilizing an online algorithm (which will be discussed in detail below). Online tuning component 104 can further be configured to track potential benefits that might be lost by not having such candidate indexes, and the utility of the existing indexes in the presence of queries, updates, and space constraints.

As online tuning component 104 gathers enough information or evidence that indicates a physical design change would be beneficial, online tuning component 104 can automatically trigger index creations or deletions (e.g., drops). By measuring evidence, online tuning component 104 can mitigate losses that might occur due to not being able to predict the future. Online tuning component 104 can estimate that a best available solution is not arbitrarily worse in performance than a current solution. Further, an index to create in place of an index that is dropped can be recommended by online tuning component 104.

Alternatively or additionally, online tuning component 104 can be configured to address the issue of index interactions with multiple indexes and/or oscillation problems. Oscillation refers to indexes that have similar benefits but dropped indexes start increasing their benefit values while newly created indexes have a bounded residual value. These issues will be discussed in further detail below.

To fully appreciate the subject embodiments, techniques for capturing information during query optimization that allow system 100 to efficiently infer cost and plan properties for varying physical designs will now be briefly discussed.

During optimization, information is gathered by utilizing an optimizer 106 and intercepting optimization rules that generate index strategies. Certain operators in the final execution plan can be tagged with annotations, which can be referred to access-path/index requests. Such requests can encode the logical properties of a physical plan that might implement a sub-tree rooted at a corresponding operator (or its right sub-tree in the case of requests tagging joins).

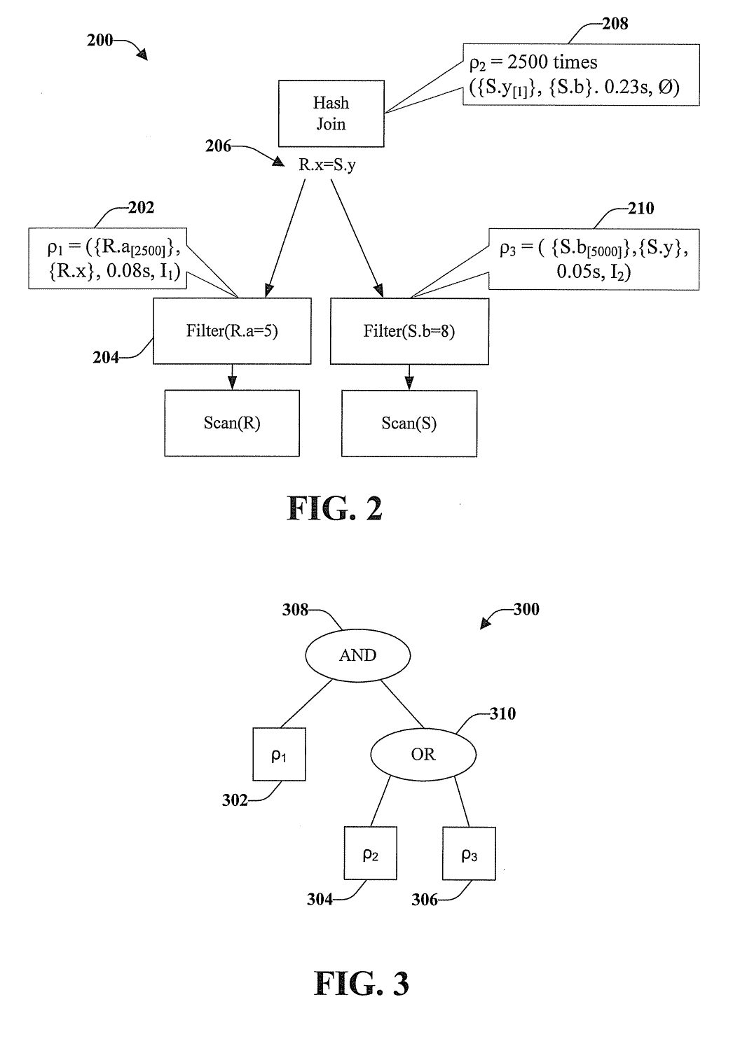

FIG. 2 illustrates an execution plan 200 for the following query:

SELECT S.b FROM R,S

WHERE R.x=S.y AND R.a=5 and S.y=8

As illustrated, request ρ₁ 202 is attached to the filter R.a=5, shown at 204, and specifies that (i) there is one sargable column R.a returning 2500 tuples, (ii) R.x 206 is required upwards in the tree, and (iii) the plan found by the optimizer costs 0.08s and uses index I₁. Similarly, request ρ₂ 208 was obtained when the optimizer attempted an index-nested loop join with R and S as the outer and inner relations. Request ρ₂ 208 specifies that S.y is a sargable column that would be sought with 2500 bindings and would produce one row for each binding (ρ₂ 208 was not implemented in the final plan, which uses a hash join).

Some requests might conflict with each other. For example, ρ₂ 208 and ρ₃ 210 are mutually exclusive. In other words, if a plan implements ρ₂ 208 with an index-nested-loop join using S as an inner table, the plan cannot simultaneously implement ρ₃ 210. FIG. 3 represents these relationships in the illustrated AND/OR request tree 300. The three requests are shown as ρ₁ 302, ρ₂ 304 and ρ₃ 306. Internal nodes 308 and 310 indicate whether their sub-trees can be satisfied simultaneously (AND) or are mutually exclusive (OR).

The requests generated during optimization can allow system 100 to make inferences about execution plans for varying physical designs while mitigating additional optimization calls. Therefore, if a physical sub-plan p is produced that implements a given request ρ, then sub-plan p can be locally replaced with the original physical sub-plan associated with request ρ, and the resulting (overall) plan should be valid and equivalent to the original plan. Since the cost of the original sub-plan is known, the cost of the newly generated alterative can be calculated. Based in part on this calculation, system 100 can infer how much the original execution plan would improve or degrade if the given sub-tree is replaced with the equivalent sub-tree.

For example, referring back to ρ₁ 202 in FIG. 2, it can be inferred what would happen if a new index I₃=(a, x) is added to the current physical design. In this example, ρ₁ 202 can be implemented by utilizing an index seek on column I₃.a returning 2500 (a, x) tuples, and passing the projection on x upwards in the tree. If the calculated cost of this alternative is, for example, 0.03s, then the overall execution plan would be (0.08s−0.03s)=0.05s more efficient than when the alternative index I₁ was originally used. Additionally, by analyzing the request, system 100 can infer the index that would result in the least expensive plan without enumerating all possibilities. In this example, I₃=(a, x) might be the best index for ρ₁ 202.

Thus, in accordance with the disclosed embodiments, a locally-optimum execution plan can be obtained instead of a globally optimum plan. In other words, physical sub-plans associated to each “winning” request in the original plan can be replaced with alternatives that should be as efficient as possible. However, in some embodiments, system 100 might not be able to obtain a plan with different join orders or other complex transformation rules that optimizers apply during plan generation. In this manner, some opportunities to obtain a globally optimal execution plan can be lost, however, there can be mitigation of expensive optimization calls and the overhead can be maintained at a lower level. The cost of the plan obtained by local changes can therefore be an approximation (tight upper bound) of the global optimal plan that the optimizer might find under the new physical design plan.

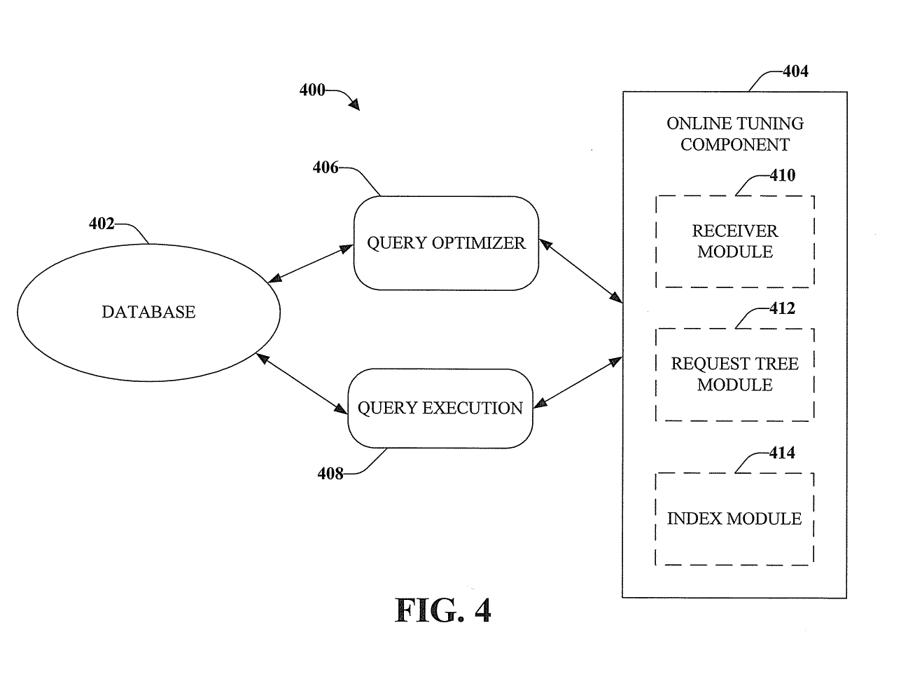

With reference now to FIG. 4, illustrated is a block-diagram of a system 400 that facilitates online physical tuning. System 400 can be a database management system (DBMS) configured to utilize algorithms that continuously monitor and modify a current physical database design by reacting to changes in a query workload.

System 400 includes a database 402 and an online tuning component 404 that can be configured to interact with each other to maintain an efficient system 400. Database 402 can interface with a query optimizer 406 that can be configured to optimize one or more queries that are included in database 402, such as in a query plan that retains the query configurations to mitigate the necessity of re-optimizing a query each time it is requested by a user. Database 402 can also interact with a component 408 that facilitates execution of the query when it is requested.

When a query is optimized or executed, information relating to the query is captured by a receiver module 410. When a query is optimized, a request tree module 412 can generate an AND/OR request tree T for the query. An index module 414 can analyze the generated AND/OR request tree T and determine or obtain the best available index that should be implemented for each request.

When a query is executed, receiver module 410 can capture information that the request tree module 412 can utilize to retrieve the AND/OR request tree T for the query. Index module 414 can then update A values for some or all of the indexes.

System 400 can be configured to utilize various algorithms to mitigate challenges associated with online physical tuning. It should be appreciated that while various algorithms are illustrated and discussed within this detailed description, various other algorithms, methods, and/or techniques can be employed with the disclosed embodiments. The following defined functions form a basis for the online algorithms that can be utilized by the systems and methods described in this detailed description.

The function getRequests(q:query): obtains the AND/OR request tree for q encoding the requirements of each index strategy that can be implemented through local transformations. The getBestIndex(ρ:request): function obtains the index that should result in the least expensive alternative implementing ρ. Approximating the cost of the best available locally transformed plan implementing ρ when {Iⱼ} are available can be performed through the getCost(ρ:request, {Iⱼ}:indexes): function.

As used herein, a physical configration is the set of indexes available at a given point in time. For a given configuration s, the cost of creating an index I can be denoted as B_{I}^{s}. It should be noted that additional indexes in s might change value B_{I}^{s}. For a workload W=(q₁,q₂, . . . , qₙ) define cost (qᵢ, sᵢ), or simply cᵢ^{s}_{ᵢ} if qᵢ is clear from the context, as the estimated cost of qᵢ when optimized under configuration sᵢ.

A configuration schedule S, as used herein, is a sequence of configurations S=(s₀, s₁, . . . , sₙ), such that before executing qᵢ the DBMS 400 is in configuration sᵢ. The cost of W under S can be defined as:

$$cost ( W , S ) = {\sum }_{i = 1}^{n} ( {c}_{i}^{{s}_{i}} + transition ( {s}_{i - 1} , {s}_{i} ) )$$

where transition(s₀, s₁)=Σ_{Iε(s}_{₁}₋ₛ_{₀}₎B_{I}^{s}^{₀}.Therefore, cost (W,S) can be the sum of each query cost in W under the corresponding configuration plus the total cost to transition between configurations in S. The optimal available configuration schedule S* is the configuration with minimum cost, therefore, S*=minargₛ(cost(W,S)). An online algorithm that solves this problem should progressively determine S=(s₀, . . . , s₀) without needing to analyze the complete workload W=(q₁, . . . , qₙ). Therefore, to determine each physical configuration sᵢ, system 400 should only need to access {q₁, . . . , qᵢ} (this assumes that so is given).

To simplify understanding of the disclosed embodiments, the following will illustrate a simple case of a single index. In this example, a physical configuration s is either 1 (when a given index I is present) or 0 (when the index I is not present or absent). Index I should be created from s=0, therefore, index I's creation cost can be denoted simply as B_{I}. The transition cost between configurations can be given by:

$$transision ( {s}_{0} , {s}_{1} ) = \{ \begin{matrix}{B}_{I} & if {s}_{o} = 0 and {s}_{I} = 1 \\ 0 & otherwise\end{matrix}$$

Obtaining the optimal schedule S* for a given workload W will now be explained with the following definition:
DEFINITION 1: For a workload W and integers i₀, i₁, define Δ(W,iₒ,i₁)=Σ(cᵢ⁰−cᵢ¹) where cᵢ⁰ (respectively cᵢ¹) is the cost of qᵢ when index I is present in (respectively, absent from) configuration sᵢ. If W is clear from the context, it can be written as Δᵢ_{₀}_{,i}_{₁}.

A sub-sequence of a workload can be measured by Δᵢ_{₀}_{,i}_{₁}. The sub-sequence of the workload can be the cumulative difference in cost between the configuration that does not contain index I (s=0) and the configuration that contains an index I (s=1). If Δᵢ_{₀}ᵢ_{₁}=C, executing queries {qᵢ_{₀}, . . . qᵢ_{₁}} without the index (s=0) is C units more expensive than executing queries with the index (s=1). Therefore, the Δ values can be an aggregated benefit (or penalty for negative Δ values) for having the index in the configuration for a given sub-sequence of the workload.

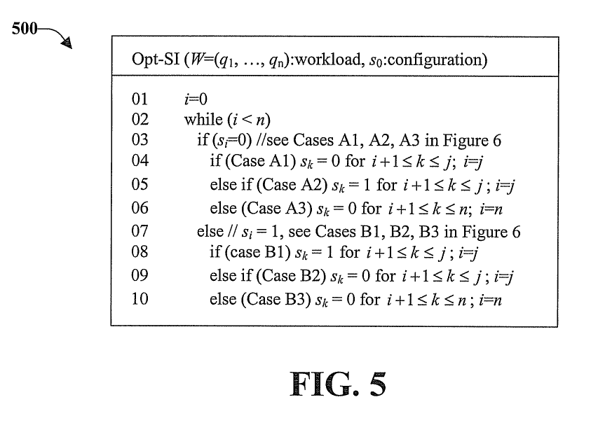

FIG. 5 illustrates an exemplary algorithm 500 for the single-index case. The algorithm 500 can be referred to as the algorithm 500 that can determine an optimal schedule S* for longer workload prefixes by using a case-by-case analysis on the future behavior of Δ, and might be referred to as the optimal algorithm for the single index case (Opt-SI) 500. Each new sub-schedule can be appended to the optimal prefix after determining whether a physical change would be beneficial.

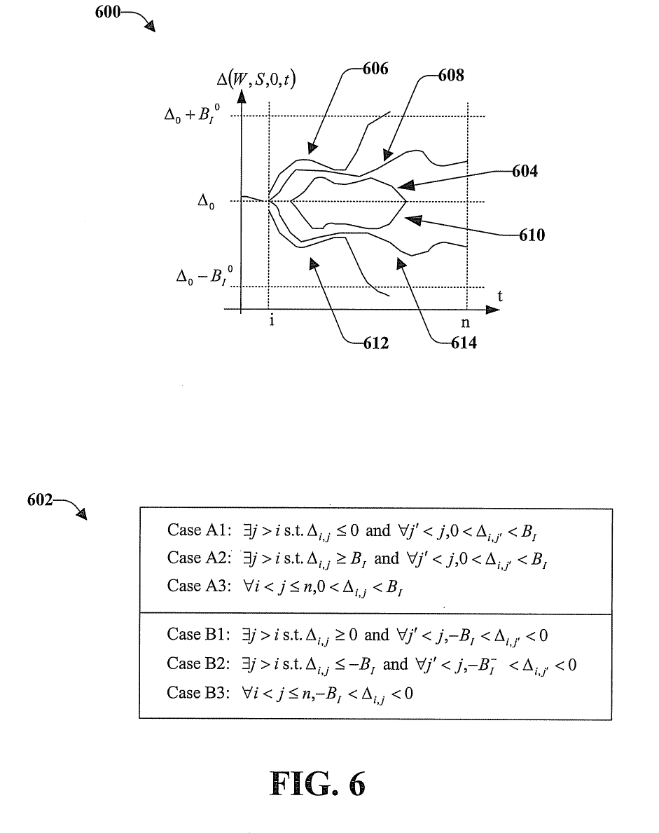

FIG. 6 illustrates a possible behavior for the single index case. The top illustrates a visual representation 600 (which is merely a representative sample) and the bottom illustrates formulas 602 for the possible behavior of Δ_{i,n}. Note that if the benefit of the index at a point in the future is larger than its creation cost and is never negative, the index should be created for that period of time. Six cases are illustrated, Case A1 (604), Case A2 (606), Case A3 (608), Case B1 (610), Case B2 (612) and Case B3 (614). The following Theorem will be utilized:
Theorem 1 Algorithm Opt-SI determines the optimal configuration schedule for an input workload W.

At any point, any instance of Δ satisfies only one among {A1, A2, A3 } and only one among {B1, B2, B3}. Algorithm Opt-SI 500, illustrated in FIG. 5, advances i at each iteration and, therefore, determines longer prefixes of the optimal schedule. Eventually, the algorithm reaches i=n and terminates. For each determination in lines 4-6 and 8-10 of the algorithm 500, an optimal schedule is reached. If sᵢ=0 and Case A2 holds, Algorithm Opt-SI 500 appends the sub-schedule S_{O}=(1, 1, . . . , 1) from positions i+1 to j.

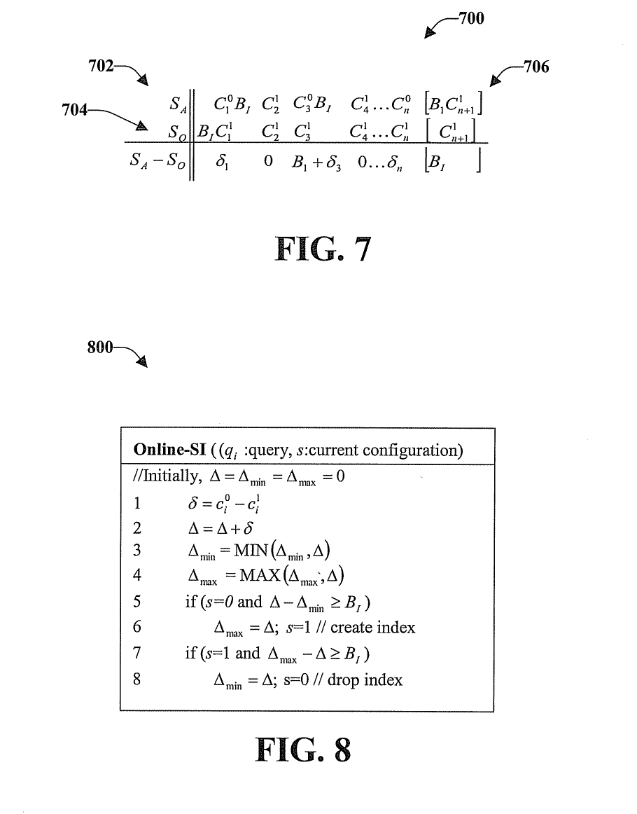

If there is an alternative schedule S_{A} that contains at least one index deletion, then S_{A} starts with a block of zero or more configurations with no index (s=0), continues with a strict alteration between blocks of configurations with the index (s=1) and without it (s=0) and optionally ends with a block of configurations with the index (s=1). The difference in cost between sub-schedules S_{A} (702) and S_{O} (704) can be obtained, as illustrated in FIG. 7, where Cᵢ⁰ and Cᵢ¹ denote the partial cost of the blocks with configuration s=0 and s=1, respectively. Before switching from s=0 to s=1 in S_{A}, the cost of creating I (B_{I}) is added. The final costs, illustrated between brackets at 706, represent the optional block with s=1.

Referring now to δ₁. According to Definition 1 (discussed above), δ₁=Δ_{i,i′} for some i<i′≦j. By definition of Case A2, it can be determined that δ₁>0. Similarly, it can be shown that δₙ=Δ_{j′,j}>0 and for each 1<k<n,|δₖ|≦B_{I} (as illustrated at 600). If all this is put together, then cost(W, S_{A}, i+1,j)>cost(W, S_{O}, i+1,j). It should be noted that schedule S_{A} might contain neither index creations nor deletions. In this case, S_{A}−S_{O}=Cₙ⁰−Cₙ¹=Δₙ>0 also. The remaining cases can be provided in a similar manner.

With reference again to Algorithm Opt-SI 500 of FIG. 5 various properties can be revealed with reference to the following example. In the last iteration a configuration block of sᵢ=0 is added. Algorithm Opt-SI 500 transitions to s=1 if Δ_{i,j}>B_{I} for some minimal j>i, and Δ_{i,j′} does not go below zero for i<j′<j. Another way of achieving the same goal can be to maintain the minimum value of Δ_{O,i} since Algorithm Opt-SI 500 lastly transitioned to s=0 (referred to as Δₘᵢₙ), and transition to s=1 if there is j>i such that Δ_{O,j}>Δₘᵢₙ+B_{I} and no j′<j satisfies Δ_{O,j′}<Δₘᵢₙ. Similarly, if s=1, the maximum value of Δ_{0,i} can be maintained since Opt-SI 500 lastly transitioned to s=1 (referred to as Δₘₐₓ), and transition to S=0 if there is a j>i such that Δ_{O,j}<Δₘₐₓ−B_{I} and no j′<j satisfies Δ_{O,j′}>Δₘₐₓ.

This alternative formulation of Algorithm Opt-SI 500 can be adapted into an online algorithm, which can be utilized with the disclosed embodiments. This online algorithm for the single index case (Online-SI) 800 is illustrated in FIG. 8. As explained above, Δₘᵢₙ and Δₘₐₓ should be maintained. However, instead of looking into the (unknown) future, configurations can be transitioned after gathering the information that proves that the optimal strategy would have done so. Line 1 of Algorithm Online-SI 800 can be utilized to obtain the expected cost of the input query under the “opposite” physical configuration. This can be done without issuing an additional optimization call by using a getCost function, as described above, over the request that used (or needed to use) index I. Therefore, both the time and space requirements for Algorithm Online-SI 800 can be very low. Space-wise, a constant amount of information per index (e.g., Δ,Δₘᵢₙ and Δₘₐₓ) should be stored. Time-wise, each time a query is executed, the Δ values can be manipulated, which cost is negligible compared to that of executing the actual queries.

Conceptually Algorithm Online-SI 800 lags behind Algorithm Opt-SI 500 and transitions the physical design after the evidence that Algorithm Opt-SI 500 gathered “from the future” has already passed. Thus, the sub-optimality of Algorithm Online-SI 800 can be bound with respect to the optimal strategy.

The following will discuss a worst-case scenario for Algorithm Online-SI 800 in which the online algorithm keeps creating and dropping index I as often as possible without exploiting the index I. The following theorem is utilized:

Theorem 2 Algorithm Online-SI is 3-competitive.

For example, worldoad W=(q₁, q₂, q₁, q₂, . . . ) where
cost (q₁, 1)=cost (q₂, 0)=ε
cost (q₁, 0)=cost (q₂, 1)=ε+B₁
   The optimal schedule for W is S*=(s₀=0, 1, 0, 1, 0, . . . ). That is to say, the index is built before each instance of q₁ and dropped before each instance of q₂. The cost of such a schedule is (B_{I}+2ε) for every pair (q₁, q₂) in W. The schedule produced by Algorithm Online-SI is S_{worst}=(s₀=0, 0, 1, 0, 1, 0, . . . ). The cost of such a schedule is (ε+B₁)+B_{I}+(ε+B_{I}), or (3B_{I}+2ε) for every pair (q₁, q₂) in W. Then the ratio:

$$\frac{cost ( W , {S}_{worst} )}{cost ( W , {S}^{*} )} = \frac{3 {B}_{I} + 2 ɛ}{{B}_{I} + 2 ɛ} < 3$$

### Since 3B_{I}+2ε<3(B_{I}+2s) and ε>0.

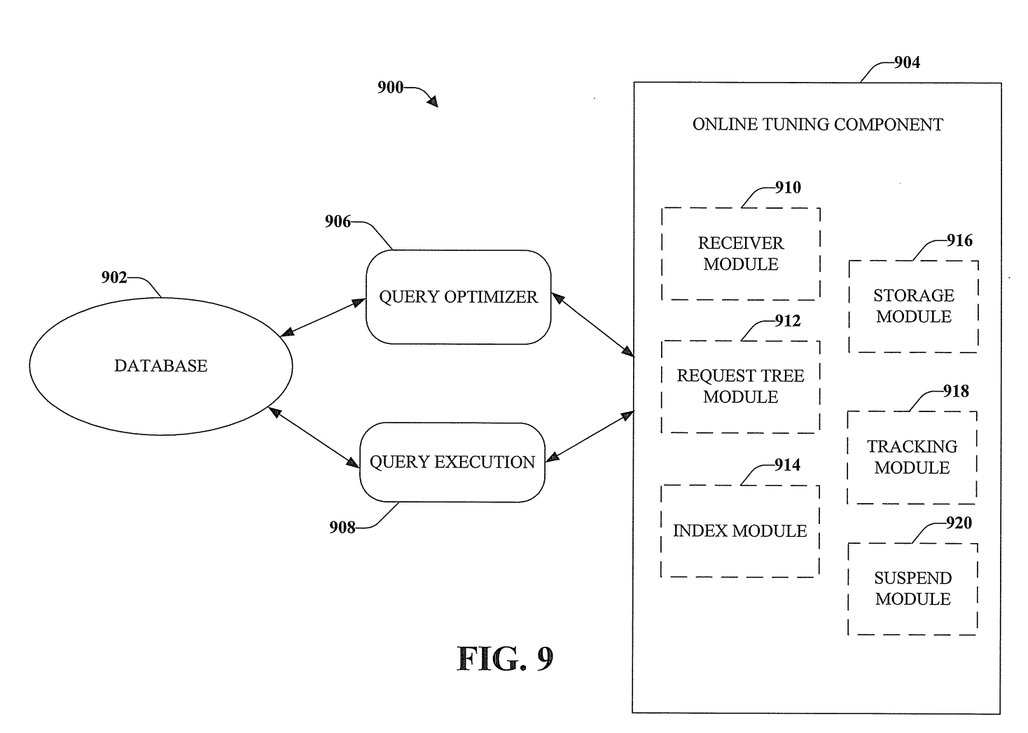

FIG. 9 illustrates a block diagram of a system 900 for online physical design tuning in accordance with the disclosed embodiments. System can include a database 902 and an online tuning component 904. Database 902 can interface with a query optimizer 906 and a query execution component 908, similar to the systems described above. Online tuning component 904 can include a receiver module 910 that can receive various information relating to the indexes when a query is optimized and/or executed. A request tree module 912 can generate an AND/OR request tree T for the query. An index module 914 can analyze the generated AND/OR request tree T and determine or obtain the best available index that should be implemented for each request. When a query is executed, receiver module 910 can capture information that request tree module 912 can utilize to retrieve the AND/OR request tree T for the query. Index module 914 can then update A values for some or all of the indexes.

The ideas presented above with reference to the single index scenario will now be discussed with reference to multiple given indexes. The definition of Δ values can be revised to reflect the multiple-index scenario.
DEFINITION 2: For a workload W, a configuration s, an index I, and integers i₀, i₁, define Δ(W,s,I,i₀,i₁)=Σᵢ₌ᵢ_{₀}ⁱ^{₁} (cᵢ^{s-{I}}−c_{I}^{s∪{I}}) where cᵢ^{s} is the cost of qᵢ under configuration s. If W, s, and I are clear from the context, it can be written as Δᵢ_{₀}_{,i}^{₁}.

Using Δ values, the Algorithm Online-SI 800 can be generated to process, for each query qᵢ, that is executed, all indexes I ε {getBestIndex(ρ): ρ ε getRequests (qᵢ)}. This generalization to multiple indexes, however, introduces two main areas: index interactions and storage constraints.

Index interactions refer to how the multiple indexes relate to each other. For example, indexes I₁=(a, b, c) and I₂=(a, b, c, d). Not considering the inherent interaction between I₁ and I₂ risks (i) underestimating Δ values for I₂ by ignoring less than optimal (but better than existing) plans that use I₂ for requests served optimally by I₁, (ii) overestimating Δ values for I₁ after creating I₂ because I₂ can be a better alternative than the original one if I₁ is not present, and similarly (iii) underestimating Δ values for I₂ if I₁ is removed from the current configuration.

Storage constraints refer to the amount of storage available. Thus, if the available storage for indexes is bounded, not all indexes I for which Δ−Δₘᵢₙ≧B_{I}^{s} could be created. In those situations, the following should occur (i) decide which indexes to create in case of competing alternatives, (ii) decide whether to drop an index I from the current configuration s even though ΔₘₐₓΔ<B_{I}^{s} to make space for better available alternatives, and (iii) consider index merging to obtain additional indexes that might better trade off space and efficiency.

When there are multiple indexes, their interactions should be considered while calculating Δ values. In addition, no more than a constant amount of information per index should be stored or else the algorithm's requirements would be too large. Approximations of index interactions by using a constant amount of additional information per index will now be discussed.

For each index I considered in configuration s, the value Δᵢ_{ₒ}_{,i}_{now}=Σᵢ₌ᵢ_{₀}ⁱ^{_{now}} cᵢ^{s-{I}}−cᵢ^{s∪{I}} can be accumulated. To simplify the notation, Oᵢ can be used instead of cᵢ^{s-{I}} and Nᵢ can be utilized instead of c₁^{s∪{I}}. For each incoming query qᵢ, the original cost for qᵢ when I is not present (Oᵢ) and the new cost of qᵢ when I is present (Nᵢ) can be obtained by using function getCost, as described above. Instead of maintaining Δ=Σ(Oᵢ−Nᵢ) , the equality Σᵢ(Oᵢ−Nᵢ)=(ΣᵢOᵢ)−(ΣᵢNᵢ) can be exploited and these two aggregates can be maintained separately. Specifically, each aggregate can be decomposed into four terms: ΣᵢOᵢ==O⁰+O¹+O²+O^{U}, and ΣᵢNᵢ=N⁰+N¹+N²+N^{U}. These values can be modified depending on how the index I is used for each request coming from the workload.

For example, if I's columns are required in no particular order, Oᵢ is added to O⁰ and Nᵢ is added to N⁰. If I's key column is required to be present (e.g., for an index seek) Oᵢ is added to O¹ and Nᵢ is added to N¹. If more than one key column in I is required to be there (e.g., for a multi-column index seek or sort request), Oᵢ is added to O² and Nᵢ is added to N². Lastly, if I is updated by the query, Oᵢ and Nᵢ from the update shell is added of O^{U} and N^{U}, respectively.

These eight value can be stored with each considered index and obtain back Δ=O⁰+O¹+O²+O^{U}−N⁰−N¹−N²−N^{U}. Since there is now more granular information available for each index, the index interactions can be handled more accurately (although still in an approximate sense). For this, the following definition can be utilized:
DEFINITION 3: Let I₁ and I₂ be indexes. The usefulness level of I₁ with respect to I₂ is given by the following table:

| Level | Condition |
|---|---|
| −1 | I₁ columns do not include I₂ columns. |
| 0 | I₁ columns include I₂ columns. |
| 1 | Additionally, I₂'s leading column agrees with I₁'s. |
| 2 | Additionally, I₂ is a prefix of I₁. |

Informally, if the usefulness level of I₁ with respect to I₂ is l≧0, then I₁ can (sub-optimally) implement requests whose costs were stored in O^{l′} and N^{l′} components of Δ for I₂ (for l′≦l). For this approximation, some indexes can help implement additional requests, but only those that keep the overhead low should be considered. For example, consider I₁=(a, b, c) and I₂=(a, c). The usefulness level of I₁ with respect to I₂ is 1, and the usefulness level of I₂ with respect to I₁ is −1. This indicates that all the requests whose costs were stored in (O⁰, N⁰) or (O¹, N¹) for I₂ can also take advantage of I₁.

Adjusting Δ values after index creation might be needed for multiple indexes. Index I can be created in a current configuration and then the Δ values for the remaining indexes considered might need to be updated to reflect the fact that the current configuration contains I.

The following is how to proceed for each index Iⱼ, which can be implemented by index module 914, illustrated in FIG. 9. First the usefulness level of I with respect to Iⱼ (referred to as lⱼ) can be found. Next for each level l≦lⱼ, set O^{l}=min(O^{l}, αⱼ·N^{l}) where αⱼ=size(Iⱼ)/size(I). The rationale for this is that if I is created, the original cost O^{l} in Iⱼ for all l≦lⱼ, might be reduced due to I. Thus O^{l} is refined for Iⱼ as the minimum between the original value and a factor αⱼ of N^{l} (the cost of index usages can be linearly extrapolated as a function of the index sizes). Since Iⱼ was optimal for the request it served, N^{l} values remain unchanged. The net effect is that the value of Δ for index Iⱼ can be potentially reduced as a result of creating I. Next Δₘᵢₙ and Δₘₐₓ can be adjusted as appropriate.

Similarly, if index I is dropped in the current configuration, Δ values of each remaining indexes Iⱼ can be updated as follows (such as by index module 914). Find the usefulness level of I with respect to Iⱼ (referred to as lⱼ). For each level l≦lⱼ, set O^{l}=β^{l}·O^{l}, where β^{l}=O^{l}/N^{l} from index I. This is because if I is dropped, the original cost O^{l} in Iⱼ for all l≦lⱼ might be increased if I was originally used to serve the corresponding requests. The original O^{l} values are then multiplied by β^{l}, the average increase in cost for level l when I is not present in the configuration. Since Iⱼ was optimal for the requests it served, the values of N^{l} remain unchanged. The net effect is the it potentially increases the value of Δ for index Iⱼ as a result of dropping I. Next Δₘᵢₙ and Δₘₐₓ can be adjusted as appropriate.

When Δ values for index I are updated, it might be because I can optimally serve some request in the workload. Less than optimal usages are not recorded explicitly, but can be approximated from the available information so that a more accurate Δ value for indexes under consideration can be obtained or Δ values for newly considered indexes, such as those resulting from index merging, can be inferred. To approximate Δ for an index I taking into account less than optimal usages can be performed as follows.

For each index Iⱼ under consideration, find lⱼ (the usefulness level of I with respect to Iⱼ). For each level l≦lⱼ, add to Δ for I the value O^{l}−αⱼ·N^{l} from Iⱼ, where αⱼ=size(I)/size(Iⱼ). Next, if I is a newly considered index, find I′, the most similar index to I among the considered ones, and subtract from Δ for I the value (O^{U}−N^{U}) from I′. Then the cost of updates for I′ can be approximated from the most similar index (e.g., the distance between I₁ and I₂ can be defined as |I₁∩I₂|/|I₁∩I₂|).

An additional type of index interaction can result from OR nodes in the AND/OR request tree. Only one of the multiple requests with an OR parent node should be implemented in an execution plan. Therefore, each time an index is created, the Δ values of the remaining indexes that were optimal for requests that shared an OR parent node should be updated. First, the optimal indexes for requests that share an OR parent node include (i) defined over substantially the same table and (ii) contain the substantially the same set of columns (in different orders). Therefore, as an approximation, an additional value in each index can be maintained that captures the fraction of (ΣᵢNᵢ) that was generated from “shared-OR nodes”. When an index I is created, the remaining indexes that share I's table and columns can be adjusted as appropriate, such as by subtracting the shared fraction from their Δ values.

With continuing reference to FIG. 9, online tuning component 904 can include a storage module 916 that can be configured to account for storage constraints. After executing an input query, there might be indexes I that should be created (e.g., indexes for which Δ−Δₘᵢₙ>B_{I}^{s}) but there is no available space to store the index and no existing indexes that can be dropped (e.g., indexes I′ ε s for which Δₘₐₓ−Δ>B_{I′}^{s}).

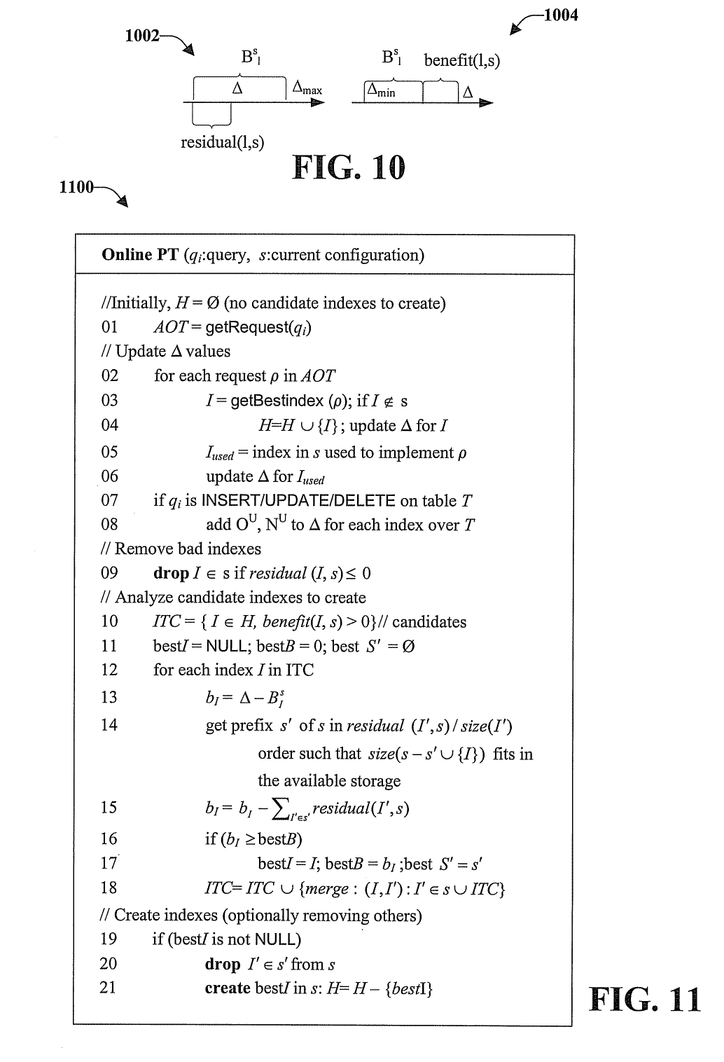

Storage module 916 can handle this situation by first defining a residual cost of an index I under configuration s as residual(I, s)=B_{I}^{s}−(Δₘₐₓ−Δ). If residual(I, s)<0, I should be dropped from s. Otherwise residual(I, s) can indicate how much slack I has before being deemed “droppable.” Also, the benefit for an index I ∉ s can be defined as benefit(I,s)=(Δ−Δₘᵢₙ)−B_{I}^{s}. If benefit(I,s)>0, index I should be added. Additionally, positive values of benefit(I,s) indicate the excess in confidence for adding I to s. FIG. 10 graphically illustrates a residual cost 1002 of an index and a benefit of an index 1004.

By way of example and not limitation, benefit(I,s)>0 for some I ∉ s, but there is no space available for creating I and, for all indexes I′ ∉ s, residual(I′,s)>0 (e.g., there are no existing indexes that can be dropped). If a subset of indexes s′ ⊂ s is found such that Σ_{I′εs′} residual(I′, s)<benefit(I,s), the benefit of creating I exceeds the combined slack of the indexes in s′. Storage module 916 can then update configuration s to s−s′ ∪ {I}. There might be many choices for I and s′ at any given time. Choosing among these alternatives will be discussed in further detail below.

In some embodiments, there may be a working set of indexes that are useful but do not fit in the available space. By definition, residual(I,s) is bounded by B_{I}^{s} for indexes I ε s. At substantially the same time, benefit(I,s) may continue to grow for I ∉ s as new queries arrive. Therefore, eventually indexes that are not in s would replace indexes in s. But now, the indexes just dropped would start increasing their benefit values while the ones just created would have a bounded residual value. This results in an endless oscillation although the relative benefits of all indexes is similar.

The following example will illustrate how to address this oscillation problem. The Δ value of some index I ε s is being updated with an additional δ, but residual (I,s)=B_{I}^{s}. After updating Δ to Δ+δ, Δₘₐₓ would also be updated appropriately and residual (I,s) would stay unchanged at B_{I}^{s}. To male this benefit explicit, in these situations, Δ values of all indexes I′ ∉ s can be proportionally decreased so that the new value of benefit (I′, s)=max (0, benefit (I′, s)-δ). That is to say, as indexes in the current configuration s are helpful, the confidence in the remaining indexes I′ ∉ s can be reduced by adjusting down their benefit values.

FIG. 11 illustrates an exemplary pseudo-code for an online algorithm 1100 for physical design tuning. Each time a query is optimized, its AND/OR request tree T can be generated and the best available index to implement for each request can be obtained, such as with, request tree module 912. When a query is executed, its AND/OR request tree T can be retrieved and Δ values can be updated for the indexes that are not in s but optimally implement some request in T (e.g., lines 3-4). A set of candidate indexes that were optimal for some request in the workload can be maintained in H. The Δ values for the indexes in s that were used to implement some request in T can be updated (lines 5-6). If the input query was an updated, the Δ values are refined (lines 7-8).

Steps 1-8 are efficient because they only manipulate in-memory scalar values. In line 9, all indexes I ε s for which ΔₘₐₓΔ>B_{I}^{s} are dropped. In lines 10-18 the current candidate indexes are analyzed and it is determined whether any indexes in s can be created (and optionally dropped). For that purpose, ITC=H can be initialized and each index in ITC can be processed. First accurate Δ values are obtained (line 13) and optionally a subset of elements from s that, if dropped, would make enough space for I to be created are found. For efficiency, the existing indexes can be statically sorted by residual (I,s)/size(I) so that indexes that are either large or are almost droppable are chosen first. In lines 15-17 the benefit of I can be adjusted by subtracting the combined residual values from s′. If the resulting benefit is the largest seen so far, I is retained as the best candidate. Finally merged indexes are generated and included in ITC for later analysis (line 18). After all indexes in ITC are processed, the best available design change (if any) is implemented in lines 19-21.

Although the online algorithm 1100 is efficient, it might impose certain overhead to the normal DBMS execution, specifically if many small queries are processed in rapid succession. To mitigate this overhead, a tracking module 918 can be utilized to throttle the online algorithm 1100. For example, tracking module 918 can track a period of time (or other event). While tracking, the online algorithm 1100, lines 1-8 (e.g., a sub-portion of the online algorithm) are executed for each query, which can impose minimal overhead and can keep the necessary information up-to-date. If the load on the database server increases, lines 9-21 can be executed once during a certain period of time, as determined by tracking module 918. This can slightly delay changes in the physical design. To further mitigate the server overhead, if needed, index merges (line 18) might only be considered in a fraction of the executions.

In some embodiments, there is a period of time between when an asynchronous online index creation in line 21 is issued and when the index is built and ready to be used. During this time, queries cannot use the index, but the online algorithm 1100 should be able to understand that the index is being created and to not consider it again for creation. This can be achieved by utilizing a suspend module 920 that can remove the index from H as soon as the creation begins so that the index is not considered again in ITC at the next iteration. However, the index's A value is updated as new queries arrive. In some embodiments, if the benefit value of the index being created goes below (−B_{I}^{s}) due to updates, the index creation can be aborted, thus saving time that might otherwise be wasted.

In some embodiments, DMBSs allow indexes to be selectively “suspended” and later selectively “restarted”. When an index is suspended, it is generally not updated and, therefore, cannot help query processing. When a suspended index is restarted, the log is read and updates are propagated to the index, which in many case is more efficient than creating the index from scratch. If this functionality is present, every time an index is dropped in line 9 (e.g., because of update costs and not due to storage constraints) the index is suspended by suspend module 920. The value I_{B}^{s} might need to be change so that it reflects the alternative procedure to bring the index back to operational mode.

In some embodiments, asynchronous statistic creation tasks can be triggered on the index key columns (e.g., if the statistics are not already present) whenever Δ−Δₘᵢₙ is greater than a fraction (e.g., 0.8) of B_{I}^{S}. Therefore, after enough evidence about the usefulness of a given index is gathered, supporting statistics can be created that have more accurate information in the near future.

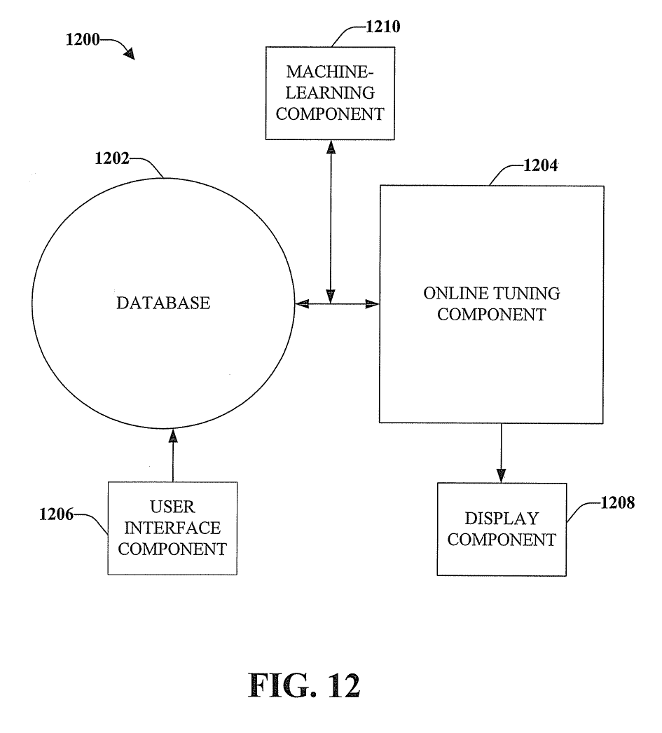

With reference to FIG. 12, illustrated is a block-diagram of a system that facilitates continuous online physical tuning. In some embodiments, a user can interface with database 1202 and/or an online tuning component 1204 and/or other system 1200 components through, for example, a user interface component 1206. It should be noted that although the disclosed embodiments can be fully updated, some users might want to be able to create and drop indexes at will. The disclosed embodiments enable this functionality. For each index that is created or dropped manually, system 1200 can adjust the A values of the remaining indexes in a similar manner as if the physical change was performed automatically.

For example, the user interface component 1206 can be, but is not limited to being, a keyboard, a mouse, a pressure-sensitive screen, a graphical user interface, a microphone, and voice recognition software. The results of the query request can be presented to the user through a display component 1208 such as a graphical user interface.

In some embodiments, a machine learning component 1210 can be utilized with the disclosed techniques. The machine-learning component 1210 can employ artificial intelligence based systems (e.g., explicitly and/or implicitly trained classifiers) in connection with performing inference and/or probabilistic determinations and/or statistical-based determinations with respect to which indexes to retain and/or drop. As used herein, the term “inference” refers generally to the process of reasoning about or inferring states of the system, environment, and/or user from a set of observations as captured through events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines, and so forth) can be employed in connection with performing automatic and/or inferred action in connection with the disclosed techniques.

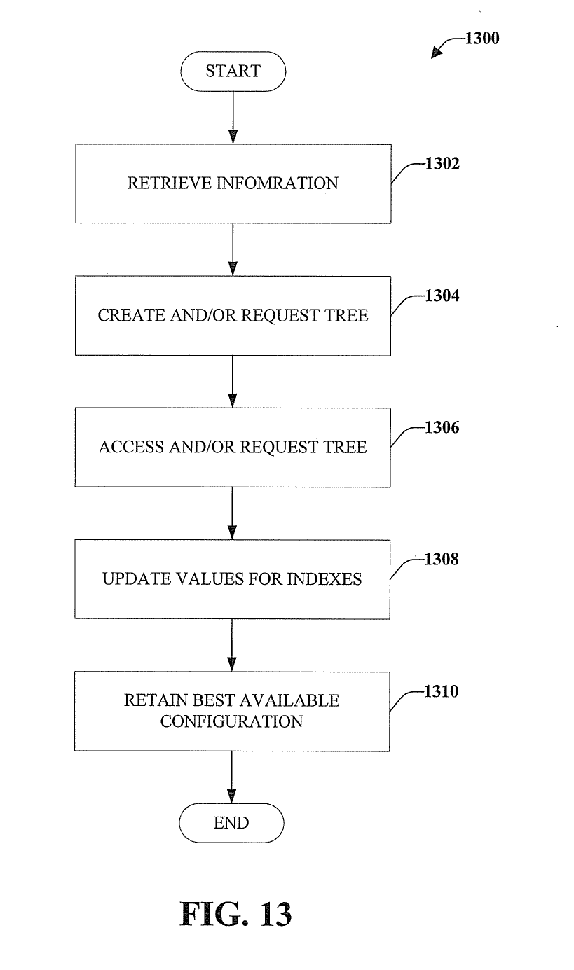

FIG. 13 illustrates a method 1300 for continuous online tuning of databases. Methods that may be implemented in accordance with the disclosed subject matter are provided throughout this disclosure. While, for purposes of simplicity of explanation, the methods are shown and described as a series of blocks, it is to be understood and appreciated that the disclosed embodiments are not limited by the number or order of blocks, as some blocks may occur in different orders and/or concurrently with other blocks from what is depicted and described herein. Moreover, not all illustrated blocks may be required to implement the methods described hereinafter. It is to be appreciated that the functionality associated with the blocks may be implemented by software, hardware, a combination thereof or any other suitable means (e.g. device, system, process, component). Additionally, it should be further appreciated that the methods disclosed hereinafter and throughout this specification are capable of being stored on an article of manufacture to facilitate transporting and transferring such methods to various devices. Those skilled in the art will understand and appreciate that a method could alternatively be represented as a series of interrelated states or events, such as in a state diagram.

Method 1300 starts, at 1302, when information is retrieved when a query is optimized. An AND/OR request tree for the optimized query can be created, at 1304. This AND/OR request tree can be maintained in various storage mediums and accessed, at 1306, when the query is executed. The values for the indexes can be updated, at 1308. The best available configuration can be retained, at 1310. Retaining the best available configuration can be based in part on the updated index values. Such retaining can include considering index interactions of multiple indexes and/or analyzing storage constraints.

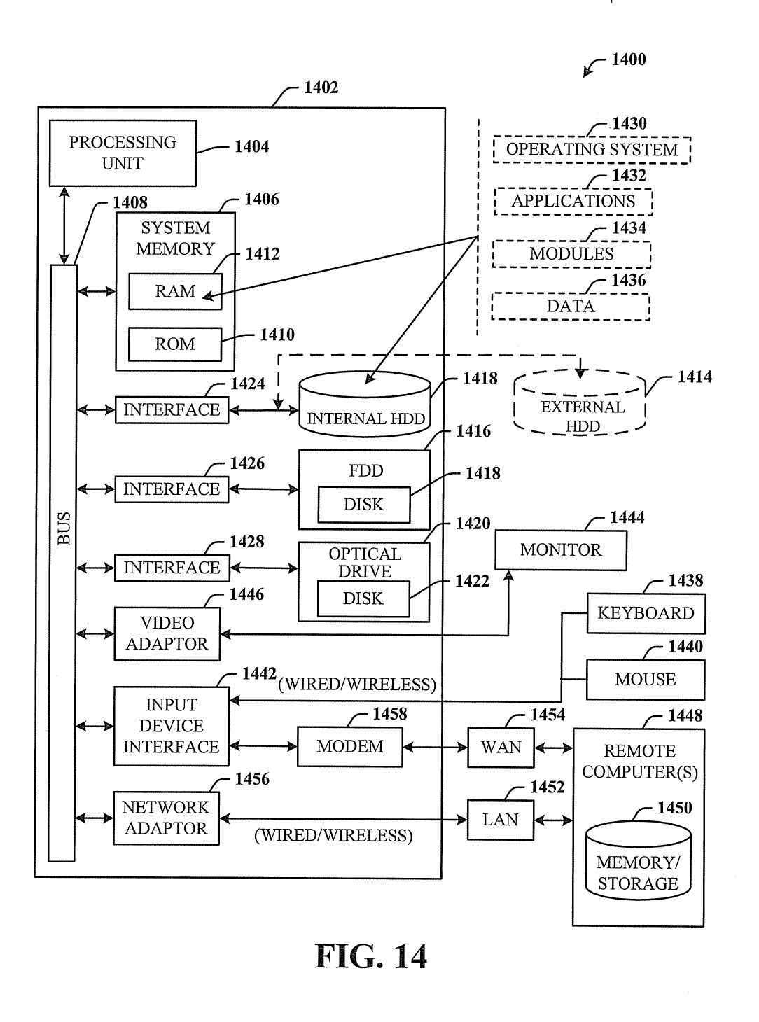

Referring now to FIG. 14, there is illustrated a block diagram of a computer operable to execute the disclosed architecture. In order to provide additional context for various aspects disclosed herein, FIG. 14 and the following discussion are intended to provide a brief, general description of a suitable computing environment 1400 in which the various aspects can be implemented. While the one or more embodiments have been described above in the general context of computer-executable instructions that may run on one or more computers, those skilled in the art will recognize that the various embodiments also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 14, the exemplary environment 1400 for implementing various aspects includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures may also be employed as the processing unit 1404.

The system bus 1408 can be any of several types of bus structure that may further interconnect to a memory bus (with or without a memory controller), a peripheral bus, and a local bus using any of a variety of commercially available bus architectures. The system memory 1406 includes read-only memory (ROM) 1410 and random access memory (RAM) 1412. A basic input/output system (BIOS) is stored in a non-volatile memory 1410 such as ROM, EPROM, EEPROM, which BIOS contains the basic routines that help to transfer information between elements within the computer 1402, such as during start-up. The RAM 1412 can also include a high-speed RAM such as static RAM for caching data.

The computer 1402 further includes an internal hard disk drive (HDD) 1414 (e.g., EIDE, SATA), which internal hard disk drive 1414 may also be configured for external use in a suitable chassis (not shown), a magnetic floppy disk drive (FDD) 1416, (e.g., to read from or write to a removable diskette 1418) and an optical disk drive 1420, (e.g., reading a CD-ROM disk 1422 or, to read from or write to other high capacity optical media such as the DVD). The hard disk drive 1414, magnetic disk drive 1416 and optical disk drive 1420 can be connected to the system bus 1408 by a hard disk drive interface 1424, a magnetic disk drive interface 1426 and an optical drive interface 1428, respectively. The interface 1424 for external drive implementations includes at least one or both of Universal Serial Bus (JSB) and IEEE 1394 interface technologies. Other external drive connection technologies are within contemplation of the one or more embodiments.

The drives and their associated computer-readable media provide nonvolatile storage of data, data structures, computer-executable instructions, and so forth. For the computer 1402, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods disclosed herein.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. It is appreciated that the various embodiments can be implemented with various commercially available operating systems or combinations of operating systems.

A user can enter commands and information into the computer 1402 through one or more wired/wireless input devices, e.g., a keyboard 1438 and a pointing device, such as a mouse 1440. Other input devices (not shown) may include a microphone, an IR remote control, a joystick, a game pad, a stylus pen, touch screen, or the like. These and other input devices are often connected to the processing unit 1404 through an input device interface 1442 that is coupled to the system bus 1408, but can be connected by other interfaces, such as a parallel port, an IEEE 1394 serial port, a game port, a USB port, an IR interface, etc.

A monitor 1444 or other type of display device is also connected to the system bus 1408 through an interface, such as a video adapter 1446. In addition to the monitor 1444, a computer typically includes other peripheral output devices (not shown), such as speakers, printers, etc.

The computer 1402 may operate in a networked environment using logical connections through wired and/or wireless communications to one or more remote computers, such as a remote computer(s) 1448. The remote computer(s) 1448 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1450 is illustrated. The logical connections depicted include wired/wireless connectivity to a local area network (LAN) 1452 and/or larger networks, e.g., a wide area network (WAN) 1454. Such LAN and WAN networking environments are commonplace in offices and companies, and facilitate enterprise-wide computer networks, such as intranets, all of which may connect to a global communications network, e.g., the Internet.

When used in a LAN networking environment, the computer 1402 is connected to the local network 1452 through a wired and/or wireless communication network interface or adapter 1456. The adaptor 1456 may facilitate wired or wireless communication to the LAN 1452, which may also include a wireless access point disposed thereon for communicating with the wireless adaptor 1456.

When used in a WAN networking environment, the computer 1402 can include a modem 1458, or is connected to a communications server on the WAN 1454, or has other means for establishing communications over the WAN 1454, such as by way of the Internet. The modem 1458, which can be internal or external and a wired or wireless device, is connected to the system bus 1408 through the serial port interface 1442. In a networked environment, program modules depicted relative to the computer 1402, or portions thereof, can be stored in the remote memory/storage device 1450. It will be appreciated that the network connections shown are exemplary and other means of establishing a communications link between the computers can be used.

The computer 1402 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from home, in a hotel room, or at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

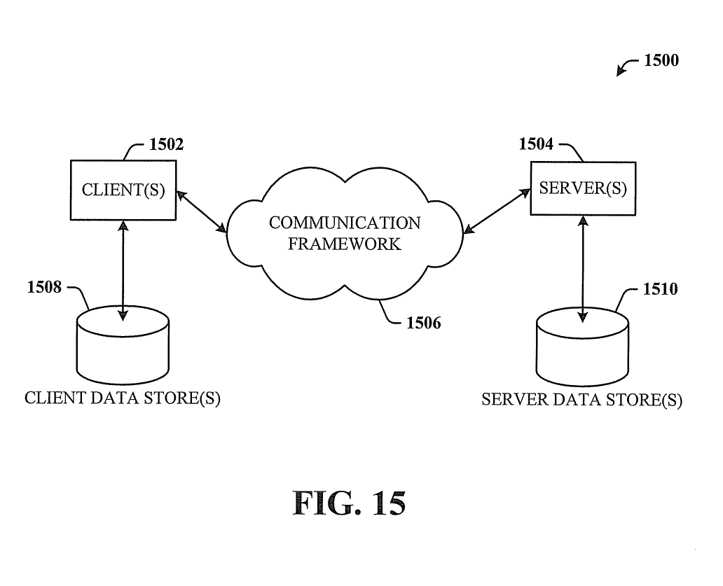

Referring now to FIG. 15, there is illustrated a schematic block diagram of an exemplary computing environment 1500 in accordance with the various embodiments. The system 1500 includes one or more client(s) 1502. The client(s) 1502 can be hardware and/or software (e.g., threads, processes, computing devices). The client(s) 1502 can house cookie(s) and/or associated contextual information by employing the various embodiments, for example.

The system 1500 also includes one or more server(s) 1504. The server(s) 1504 can also be hardware and/or software (e.g., threads, processes, computing devices). The servers 1504 can house threads to perform transformations by employing the various embodiments, for example. One possible communication between a client 1502 and a server 1504 can be in the form of a data packet adapted to be transmitted between two or more computer processes. The data packet may include a cookie and/or associated contextual information, for example. The system 1500 includes a communication framework 1506 (e.g., a global communication network such as the Internet) that can be employed to facilitate communications between the client(s) 1502 and the server(s) 1504.

Communications can be facilitated through a wired (including optical fiber) and/or wireless technology. The client(s) 1502 are operatively connected to one or more client data store(s) 1508 that can be employed to store information local to the client(s) 1502 (e.g., cookie(s) and/or associated contextual information). Similarly, the server(s) 1504 are operatively connected to one or more server data store(s) 1510 that can be employed to store information local to the servers 1504.

What has been described above includes examples of the various embodiments. It is, of course, not possible to describe every conceivable combination of components or methodologies for purposes of describing the various embodiments, but one of ordinary skill in the art may recognize that many further combinations and permutations are possible. Accordingly, the subject specification intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. To the extent that the terms “includes,” and “including” and variants thereof are used in either the detailed description or the claims, these terms are intended to be inclusive in a manner similar to the term “comprising.” Furthermore, the term “or” as used in either the detailed description or the claims is meant to be a “non-exclusive or”.

What is claimed is:

1. A system that facilitates online continuous database tuning, comprising:
a database system that optimizes or executes queries; and
an online tuning component that continuously monitors the optimized or executed query and determines at least one of an index to keep or an index to drop by utilizing an online algorithm.

2. The system of claim 1, the online tuning component further estimates that a best available solution is not arbitrarily worse in performance than a current solution.

3. The system of claim 1, further comprising:
a request tree module that generates an AND/OR request tree when a query is optimized; and
an index module that obtains a best available index to implement each request.

4. The system of claim 1, further comprising:
a request tree module that retrieves an AND/OR request tree for an executed query; and
an index module that updates A values for one or more indexes in the tree.

5. The system of claim 1, further comprising a user interface component that accepts a user initiated index creation or index drop.

6. The system of claim 1, the online tuning component continuously implements at least a sub-portion of the algorithm until a predetermined amount of time is met or exceeded.

7. The system of claim 1, further comprising a suspend module that suspends at least one index and restarts the at least one index at a later time.

8. The system of claim 1, further comprising a storage module that determines a best available index to keep or an index to drop based in part on storage constraints.

9. The system of claim 1, further comprising an index module that approximates index interactions by using a constant amount of additional information per index.

10. The system of claim 1, the online tuning component can recommend an index to create in place of the index that is dropped.

11. A method for continuous online tuning of databases, comprising:
retrieving information when a query is optimized;
creating an AND/OR request tree for the optimized query;
accessing the AND/OR request tree when the query is executed;
updating values for indexes; and
retaining the best available configuration based in part on the updated index values.

12. The method of claim 11, further comprising utilizing at least a portion of an online physical tuning algorithm to determine whether an index should be dropped or created.

13. The method of claim 12, further comprising implementing a sub-portion of the online physical tuning algorithm for a predetermined amount of time.

14. The method of claim 11, further comprising accepting a user manipulation to at least one index.

15. The method of claim 11, retaining the best available index further comprising considering index interactions of multiple indexes.

16. The method of claim 11, retaining the best available index further comprising analyzing storage constraints.

17. The method of claim 11, further comprising selectively suspending and restarting at least one index.

18. A computer executable system for continuous online physical database tuning, comprising:
means for evaluating a query AND/OR request tree;
means for updating index values for indexes contained in the AND/OR request tree; and
means for selectively dropping or creating an index based in part on the updated index values.

19. The computer executable system of claim 18, further comprising means for implementing the best available design change.

20. The computer executable system of claim 18, further comprising means for mitigating overhead by selectively running one or more portions of an algorithm to determine which index should be dropped or created.
